(19) United States
(12) Patent Application Publication
(10) Pub. No.: US 2005/0040565 A1
(43) Pub. Date: Feb. 24, 2005

(54) Method of manufacturing a non-woven fabric

(76) Inventors: Sebastian Sommer, Troisdorf (DE); Michael Baumeister, Troisdorf (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/902,691

(22) Filed: Jul. 29, 2004

(30) Foreign Application Priority Data
Aug. 20, 2003 (DE) 10338196.1

(51) Int. Cl. B27N 1/00

(52) U.S. Cl. 264/518; 264/175

(57) ABSTRACT

A method for manufacturing a nonwoven fabric, wherein a layer of nonwoven fabric is made up of a fiber mixture of at least two different types of fibers is formed. The single nonwoven fabric layer is solidified. The solidified single nonwoven fabric layer is then subjected to heat treatment subject to the condition that shrinkage of at least one of the types of fibers is activated.

### FIELD OF THE INVENTION

The present invention relates to a method of manufacturing a nonwoven fabric, wherein a layer of nonwoven fabric comprising a fiber mixture of at least two different types of fibers is formed. The fibers preferably comprise filaments of thermoplastic plastic.

### BACKGROUND OF THE INVENTION

Numerous methods for manufacturing nonwoven fabrics are known in practice. If nonwoven fabrics having high strength and high stiffness are produced, these nonwoven fabrics are generally distinguished by a relatively low thickness. In other words, these nonwoven fabrics are only relatively low in volume and thus frequently have an inadequate textile feel or hand. Special process steps for increasing the thickness or the volume, such as needling the nonwoven fabric are particularly uneconomical for the light nonwoven products typical in the hygiene area.

### OBJECTS OF THE INVENTION

The object of the invention is to provide a method of the type specified initially with which the volume bulk or the thickness of a nonwoven fabric can be increased in a simple and inexpensive fashion.

### SUMMARY OF THE INVENTION

This object is achieved in a method of manufacturing a nonwoven fabric, wherein a layer of nonwoven fabric comprising a fiber mixture of at least two different types of fibers is formed and the single nonwoven fabric layer is solidified or compacted and wherein the compacted single nonwoven fabric layer is then subjected to a heat treatment which activates shrinkage of at least one of the types of fibers.

The term “a single nonwoven fabric layer” according to one embodiment of the invention means a layer aggregate which is formed of a plurality of identical nonwoven fabric layers. Thus, a plurality of identical nonwoven fabric layers having identical fiber mixtures and thus identical shrinking properties are formed one on top of the other so that a virtually homogeneous layer aggregate is formed. In this case, it is within the scope of the invention that these identical spinning nonwoven fabric layer, which is then compacted and is preferably stabilized in a calender, also forms such a layer aggregate.

It is within the scope of the invention that the fibers of the fiber mixture comprise continuous fibers or filaments which appropriately consist of thermoplastic plastic. According to a very preferred embodiment of the invention, the single nonwoven fabric layer is present in the form of a homogeneous fiber mixture before the solidification. In other words, the at least two types of fibers are homogeneously distributed in the nonwoven fabric layer. In this context, homogeneously means that the fibers are distributed substantially homogeneously in the nonwoven fabric layer. In this connection it is in any case within the scope of the invention that no different layers or plies are formed with the different types of fibers. The use of the term fibers here is intended to include continuous strands as well as subdivided strands of relatively short length. It is furthermore within the scope of the invention that the two types of fiber of the fiber mixture exhibit different shrinkage behavior during heat treatment. The fiber mixture used according to the invention thus comprises a shrinkable fiber mixture whose different types of fibers shrink at different temperatures.

According to a very preferred embodiment of the invention, the different types of fibers forming the nonwoven fabric layer are produced using a single spinning tool. According to this embodiment, a nonwoven fabric layer according to the invention is thus suitably produced in a spinning shaft as mixed fiber laying. According to an especially preferred embodiment of the invention, a spinning tool is used within the scope of this embodiment which is normally used to produce bicomponent fibers or multicomponent fibers. In this case, the different components or the different types of fibers emerge from respectively different spinning orifices, nozzles, openings or capillaries of the spinning tool. An approximately equal spinning speed of the different components or the different types of fibers can be ensured by varying the respective hole densities and the throughputs per capillary.

It is furthermore within the scope of the invention that the two types of fibers consist of different plastics. According to a very preferred embodiment of the invention, at least one of the two types of fibers consists of at least one plastic from the group “polyolefin, polyester, polyamide”. The two types of fibers can also consist of copolymers of these plastics. According to one embodiment, the first type of fiber consists of a polyolefin and the second type of fiber consists of a polyester. The polyolefin suitably consists of polyethylene terephthalate (PET) or polybutylene terephthalate (PBT). According to one embodiment of the invention one type of fiber of the fiber mixture consists of polypropylene and the second type of fiber of the fiber mixture consists of polyethylene terephthalate (PET). Another embodiment of the invention is characterized in that one type of fiber of the fiber mixture consists of polypropylene and that the second type of fiber consists of polybutylene terephthalate (PBT). According to another embodiment of the invention, the first type of fiber of the fiber mixture consists of polyethylene and the second type of fiber of the fiber mixture consists of polypropylene.

The fibers used for the fiber mixture preferably comprise monofilaments. However, it is fundamentally also within the scope of the invention that one type of fiber of the fiber mixture consists of multi-component fibers or multi-component filaments and especially of bicomponent fibers or bicomponent filaments. However, the use of monofilaments for the two or for all types of fibers of the fiber mixtures is preferred.

It is within the scope of the invention that the two types of fibers of the fiber mixture exhibit different shrinkage behaviors during the heat treatment. As a result of a special choice of the raw material for the fibers and/or by adjusting the spinning conditions, the different fiber components have different shrinkage potentials in a certain temperature range.

According to a very preferred embodiment which acquires quite particular importance within the scope of the invention, the single nonwoven fabric layer is solidified using a calender. In this case, it is within the scope of the invention that a calender roller or a pair of calender rollers is used for solidification. Preferably a calender roller or a pair of calender rollers is used, which has engraving points with average engraving-point distances over 1.5 mm, preferably over 2.5 mm. According to a preferred embodiment these are average engraving-point distances.

According to a preferred embodiment of the invention the heat treatment of the solidified nonwoven fabric layer is carried out using a warmed or heated fluid. The heat treatment is suitably carried out using hot air. In this respect, the heat treatment can be carried out in a hot-air furnace. For example, a drum drier can be used.

The different shrinkage of the two types of fibers is used during the heat treatment. In this case, the fiber component with the higher shrinkage draws the engraving points or connecting points together whereas the fiber components with the lower shrinkage must as it were change in thickness.

The invention is based on the knowledge that voluminous nonwoven fabric having excellent properties can be produced simply and cheaply by the method according to the invention. Relatively thick and voluminous nonwoven fabric with excellent textile feel is produced. It should be emphasized that the method can be carried out relatively cheaply and thus the nonwoven fabrics produced are also distinguished by favorable cost.

### BRIEF DESCRIPTION OF THE DRAWING

The above and other objects, features, and advantages will become more readily apparent from the following description, reference being made to the accompanying drawing in which:

FIG. 1 is a flow diagram illustrating the method of making the nonwoven fabric; and

FIG. 2 is a diagrammatic cross section through the fabric.

### SPECIFIC DESCRIPTION

From FIG. 2 it will be apparent that the nonwoven fabric 10 made by the method of the invention is a single compressed layer 10 formed from at least two different types of fibers or filaments 11 and 12 which have been shown as unshaded and shaded, respectively to allow the fibers or filaments to be distinguished. The two types of fibers or filaments are produced by a single spinning tool and consist of different plastics, respectively labeled high shrinkage and low shrinkage respectively. At least one of the two types of fibers consists of a polyolefin, polyester or polyamide or a mixture thereof and one of the two types of filaments can have been thermally shrunk to a substantially greater extent than the other. The filaments may be bonded together at crossovers 13.

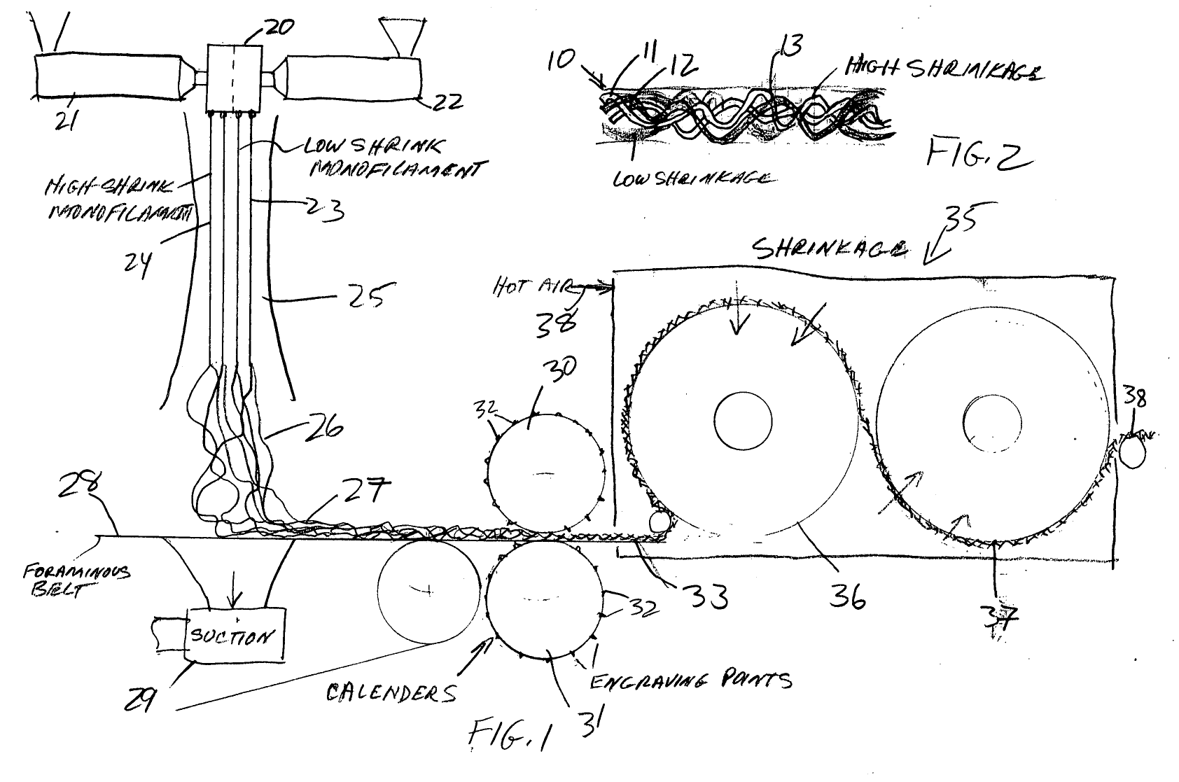

In FIG. 1, we have shown the apparatus for carrying out the method of the invention.

The apparatus can comprise a single spinning tool 20 which may be internally subdivided so that the spinning nozzles can be supplied with the two different plastics from respective plastifiers or extruders 21 and 22 and thus generate two different types of monofilament 23 and 24, respectively identified as a low shrinkage monofilament and a high shrinkage monofilament. The monofilaments as they emerge from the spinning tool 20 can be broken up in accordance with spun bond principles if desired.

Below an aerodynamic stretching zone 25, the filaments or fibers jumble together randomly at 26 to produce a thick nonwoven fabric or mat 27 consisting of a single nonwoven fabric layer in the form of a fiber or filament mixture of at least the two different types of fibers on a foranious belt 28 below which a suction is generated by a blower 29 to draw the fibers against the belt.

The single nonwoven fabric layer 27 is virtually homogeneous even if made up of identical nonwoven fabric layers which in the layer 27 cannot be distinguished from one another.

The nonwoven fabric, consisting of two types of fiber in the fiber mixture exhibiting different shrinkage behavior during heat treatment, is passed through a calender consisting of rollers 30 and 31 with engraving points 32 with a minimum of spacing of 1.5 mm and preferably 2.5 mm. The calendered compacted or solidified nonwoven fabric layer 33 is subjected to heat treatment at a temperature sufficient to shrink at least one of the types of filaments or fibers. The shrinkage unit 35 may comprise drums 36, 37 which are perforated and upon the surface of which the nonwoven fabric 33 is carried so that hot air fed at 38 to the unit 35 will pass through the nonwoven fabric into the evacuated drums. The finished fabric exits the drum dryer 35 at 38.

1. A method of making a nonwoven fabric, comprising the steps of:
(a) depositing a fiber mixture of at least two different types of fiber in a single nonwoven fabric layer;
(b) compacting said nonwoven fabric layer into a compacted nonwoven fabric layer; and
(c) heat treating said compacted nonwoven fabric layer to activate a thermal shrinkage of at least one of said types of fiber to yield said nonwoven fabric.

2. The method defined in claim 1 wherein the fiber mixture is deposited in step (a) from a single spinning tool.

3. The method defined in claim 2 wherein said two types of fiber consist of different plastics.

4. The method defined in claim 3 wherein one of said types of fiber is composed of a plastic selected from the group which consists of polyolefins, polyesters, polyamides and mixtures thereof.

5. The method defined in claim 4 wherein said nonwoven fabric layer is compacted into said compacted nonwoven fabric layer by calendering.

6. The method defined in claim 5 wherein said nonwoven fabric layer is compacted into said compacted nonwoven fabric layer between calender rolls having engraving points with a spacing of at least 1.5 mm.

7. The method defined in claim 6 wherein said spacing is at least 2.5 mm.

8. The method defined in claim 7 wherein said heat treatment of said compacted nonwoven fabric layer to activate said thermal shrinkage of at least one of said types of fiber to yield said nonwoven fabric is carried out using a heated fluid.

9. The method defined in claim 8 wherein the heat treatment of said compacted nonwoven fabric layer to activate said thermal shrinkage of at least one of said types of fiber to yield said nonwoven fabric is carried out in hot air.

10. The method defined in claim 1 wherein said two types of fiber consist of different plastics.

11. The method defined in claim 1 wherein one of said types of fiber is composed of a plastic selected from the group which consists of polyolefins, polyesters, polyamides and mixtures thereof.

12. The method defined in claim 1 wherein said nonwoven fabric layer is compacted into said compacted nonwoven fabric layer by calendering.

13. The method defined in claim 1 wherein said nonwoven fabric layer is compacted into said compacted nonwoven fabric layer between calender rolls having engraving points with a spacing of at least 1.5 mm.

14. The method defined in claim 12 wherein said spacing is at least 2.5 mm.

15. The method defined in claim 1 wherein said heat treatment of said compacted nonwoven fabric layer to activate said thermal shrinkage of at least one of said types of fiber to yield said nonwoven fabric is carried out using a heated fluid.

16. The method defined in claim 1 wherein the heat treatment of said compacted nonwoven fabric layer to activate said thermal shrinkage of at least one of said types of fiber to yield said nonwoven fabric is carried out in hot air.
